(19) United States
(12) Patent Application Publication
(10) Pub. No.: US 2017/0359596 A1
(43) Pub. Date: Dec. 14, 2017

(54) VIDEO CODING TECHNIQUES EMPLOYING MULTIPLE RESOLUTION

(71) Applicant: Apple Inc., Cupertino, CA (US)

(72) Inventors: Jae Hoon Kim, San Jose, CA (US); Xiaosong ZHOU, Campbell, CA (US); Sudeng Hu, San Jose, CA (US); Chris CHUNG, Sunnyvale, CA (US); Dazhong ZHANG, Milpitas, CA (US); Hsi-Jung WU, San Jose,, CA (US)

(21) Appl. No.: 15/178,304

(22) Filed: Jun. 9, 2016

(51) Int. Cl. H04N 19/59; H04N 19/61; H04N 19/167; H04N 19/182

(52) U.S. Cl. CPC H04N 19/59; H04N 19/182; H04N 19/61; H04N 19/167

(57) ABSTRACT

Video coding techniques are disclosed that can accommodate low bandwidth events and preserve visual quality, at least in areas of an image that have high significance to a viewer. Region(s) of interest may be identified from content of input frame that will be coded. Two representations of the input frame may be generated at different resolutions. A low resolution representation of the input frame may be coded according to predictive coding techniques in which a portion outside the region of interest is coded at higher quality than a portion inside the region of interest. A high resolution representation of the input frame may be coded according to predictive coding techniques in which a portion inside the region of interest is coded at higher quality than a portion outside the region of interest. Doing so preserves visual quality, at least in areas of the input image that correspond to the region of interest.

### BACKGROUND

The present disclosure is directed to video coding systems.

Many modern electronic devices support video coding techniques, which find use in video conferencing applications, media delivery applications and the like. Many of these coding applications, particularly video conferencing and video streaming applications, require coding and decoding to be performed in real-time.

In real-time applications, communication bandwidth can change erratically and, for many communication networks (such as cellular networks), bandwidth can be very low (e.g., lower than 50 Kbps for 480×360, 30 fps video sequences). To meet the bandwidth limitations, video coders compress the video sequences heavily as compared to other scenarios where bandwidth is much higher. Heavy compression can introduce severe coding artifacts, like blocking artifacts, which lowers the perceptible quality of such coding sessions. And while it may be possible to reduce resolution of an input sequence to code the lower resolution representation at higher relative quality, doing so causes the sequence to look blurred on decode because the content lost by sub-sampling into smaller resolution cannot be recovered.

Accordingly, the inventors have identified a need in the art for a coding/decoding technique that responds to loss of bandwidth by compressing video sequences without introducing visual artifacts in areas of viewer interest.

### BRIEF DESCRIPTION OF THE DRAWINGS

FIG. 1 is a simplified block diagram of an encoder/decoder system according to an embodiment of the present disclosure.

FIG. 2 is a simplified functional block diagram of a coding system according to an embodiment of the present disclosure.

FIG. 3 illustrates exemplary image data and process flow for the image data when acted upon by the coding system of FIG. 2.

FIG. 4 illustrates a method according to an embodiment of the present disclosure.

FIG. 5 illustrates relationships between base layer prediction references and enhancement layer prediction references according to an embodiment of the present disclosure.

FIG. 6 illustrates exemplary image data, regions and zones according to an embodiment of the present disclosure.

FIG. 7 is a simplified functional block diagram of a coding system according to another embodiment of the present disclosure.

FIG. 8 illustrates variable resolution adaptation according to an embodiment of the present disclosure.

FIG. 9 is a simplified functional block diagram of a coding system according to another embodiment of the present disclosure.

FIG. 10 illustrates a method according to an embodiment of the present disclosure.

FIG. 11 illustrates exemplary transform coefficients according to an embodiment of the present disclosure.

FIG. 12 shows frames of an exemplary coding session according to an embodiment of the present disclosure.

FIG. 13 is a simplified functional block diagram a decoding system according to an embodiment of the present disclosure.

### DETAILED DESCRIPTION

Embodiments of the present disclosure provide coding techniques that can accommodate low bandwidth events and preserve visual quality, at least in areas of an image that have high significance to a viewer. According to these techniques, region(s) of interest may be identified from content of input frame that will be coded. Two representations of the input frame may be generated at different resolutions. A low resolution representation of the input frame may be coded according to predictive coding techniques in which a portion outside the region of interest is coded at higher quality than a portion inside the region of interest. A high resolution representation of the input frame may be coded according to predictive coding techniques in which a portion inside the region of interest is coded at higher quality than a portion outside the region of interest. Doing so preserves visual quality, at least in areas of the input image that correspond to the region of interest.

These techniques may take advantage of scalable extensions (colloquially, scalable video coding or “SVC”) of a coding protocol under which the coder operates. For example, the H.264/AVC and H.265/HEVC coding protocols permit coding of image data in different layers at different resolutions. Thus, a single video sequence can be encoded at lower resolution in a base layer and with inter-layer prediction, encoding at higher resolution the enhancement layer. SVC is used to generate scalable bit streams, which can be decoded into sequences in different resolutions according to user's requirements and network condition, for example, in multicast.

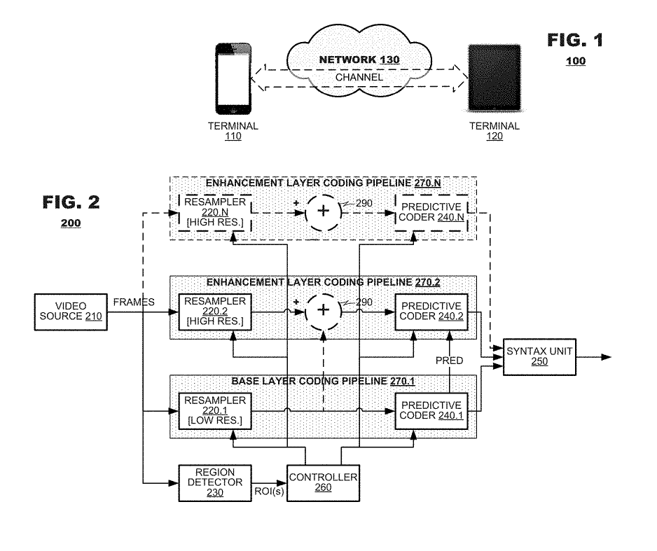

FIG. 1 is a simplified block diagram of an encoder/decoder system 100 according to an embodiment of the present disclosure. The system 100 may include first and second terminals 110, 120 interconnected by a network 130. The terminals 110, 120 may exchange coded video data with each other via the network 130, either in a unidirectional or bidirectional exchange. For unidirectional exchange, a first terminal 110 may capture video data from local image content, code it and transmit the coded video data to a second terminal 120. The second terminal 120 may decode the coded video data that it receives and display the decoded video at a local display. For bidirectional exchange, each terminal 110, 120 may capture video data locally, code it and transmit the coded video data to the other terminal. Each terminal 110, 120 also may decode the coded video data that it receives from the other terminal and display it for local viewing.

Although the terminals 110, 120 are illustrated as smartphones and tablet computers in FIG. 1, they may be provided as a variety of computing platforms, including servers, personal computers, laptop computers, tablet computers, media players and/or dedicated video conferencing equipment. The network 130 represents any number of networks that convey coded video data among the terminal 110 and terminal 120, including, for example, wireline and/or wireless communication networks. A communication network 130 may exchange data in circuit-switched and/or packet-switched channels. Representative networks include telecommunications networks, local area networks, wide area networks and/or the Internet. For the purposes of the present discussion, the architecture and topology of the network 130 is immaterial to the operation of the present disclosure unless discussed hereinbelow.

FIG. 2 is a functional block diagram of a coding system 200 according to an embodiment of the present disclosure. The coding system may code video data output by a video source 210 at multiple resolutions. The system may include a plurality of resamplers 220.1, 220.2, . . . , 220.N, a region detector 230, a plurality of predictive coders 240.1, 240.2, . . . , 240.N, and a syntax unit 250 all operating under control of a controller 260. The resamplers 220.1, 220.2, . . . , 220.N and the predictive coders 240.1, 240.2, . . . , 240.N may be assigned to each other in pairwise fashion to define coding pipelines 270.1, 270.2, . . . , 270.N for a coded base layer and one or more coded enhancement layers. The present discussion is directed to a two-layer scalable coding system, having a base layer and only a single enhancement layer, but the principles of the present discussion may be extended to a coding system having additional enhancement layers, as desired.

Each resampler 220.1, 220.2, . . . , 220.N may alter resolution of source frames presented to its respective pipeline to a resolution of the respective layer. By way of example, a base layer may code video at Quarter Video Graphics Array (commonly, “QVGA”) resolution, which has a 320×240 in width and height, and an enhancement layer may code video at Video Graphics Array (“VGA”) resolution, which is 640×480 in width and height. Each respective resampler 220.1, 220.2, . . . , 220.N may resample input video to meet the resolutions defined for its respective layer. In many cases, source video may be resampled to meet the resolution of the respective layer but, in some cases, resampling may be omitted if the source video resolution is equal to the resolution of the layer. The principles of the present disclosure find application with other coding formats described herein and even formats that may be defined in the future, in which coding resolutions may meet or exceed the resolutions of the video sources that provide image data for coding.

As discussed herein, in some embodiments, coding resolutions of each layer may change dynamically during operation, for example, to meet HVGA (480×320), WVGA (768×480), FWVGA (854×480), SVGA (800×600), DVGA (960×640) or WSVGA (1024×576/600) formats, in which case, operations of the resamplers 220.1, 220.2, . . . , 220.N may change dynamically to meet the layer's changing coding requirements. Video data in the enhancement layer pipeline 270.2 may have higher resolution than video data in the base layer pipeline 270.1. Where multiple enhancement layers are used, video data in higher level enhancement layer pipelines (say, layer 270.N) may have higher resolution than video data in lower level enhancement layer pipelines 270.2.

The region detector 230 may identify regions of interest (“ROIs”) within image content. ROIs represent areas of image content that are deemed by analysis to represent important image content. ROIs, for example, may be identified from object detection performed on image content (e.g., faces, textual elements or other objects with predetermined characteristics). Alternatively, they may be identified from foreground/background discrimination, which may be identified image activity (e.g., regions of high motion activity may represent foreground objects) or from image activity that contradicts estimates of overall motion in a field of view (for example, an object that is maintained in a center field of view against a moving background). Similarly, ROIs may be identified from location of image content within a field of view (for example, image content in a center area of an image as compared to image content toward a peripheral area of a field of view). And, of course, multiple ROIs may be identified simultaneously in a common image. The region detector 230 may output identifiers of ROI(s) to the controller 260.

The coders 240.1, 240.2, . . . 240.N may code the video data presented to them according to predictive coding techniques. The coding techniques may conform to a predetermined coding protocol defined for the video coding system and for the layer to which the respective coder belongs. Typically, each frame of video data is parsed into predetermined arrays of pixels (called “pixel blocks” herein for convenience) and coded. Partitioning may occur according to a predetermined partitioning scheme, which may by defined by the coding protocol to which the coders 240.1, 240.2, . . . 240.N conform. For example, HEVC-based coders may partition images recursively into coding units of various sizes. H.264-based coder may partition images into macroblocks or blocks. Other coding systems may partition image data into other arrays of image data.

The coders 240.1, 240.2, . . . 240.N may code each input pixel block according to a coding mode. For example, pixel blocks may be assigned a coding type, such as intra-coding (I-coding), uni-directionally predictive coding (P-coding), bi-directionally predictive coding (B-coding) or SKIP coding. SKIP coding causes no coded information to be generated for the pixel block; at a decoder (not shown), its content will be derived wholly from a pixel block located in a preceding frame by neighboring motion vectors. For I-, P- and B-coding, an input pixel block is coded differentially with respect to a predicted pixel block that is derived according to an I-, P- or B-coding mode, respectively. Prediction residuals representing a difference between content of the input pixel block and content of the predicted pixel block may be coded by transform coding, quantization and entropy coding. The coders 240.1, 240.2, . . . 240.N may include decoders and reference picture caches (not shown) that decode data of coded frames that are designated reference frames; these reference frames provided data from which predicted pixel blocks are generated to code new input pixel blocks.

During operation, an enhancement layer coding pipeline 270.2 may be configured to code image data that belongs to an ROI at higher image quality than image data outside the ROI. Similarly, the base layer coding pipeline 270.1 may be configured to coded image data outside the ROI at a higher image quality than image data within the ROI. When a decoder at a far end terminal (not shown) decodes the coded enhancement layer and base layer streams, it may obtain a high quality, high resolution representation of ROI data primarily from the enhancement layer and a high quality albeit lower resolution representation of non-ROI data primarily from the base layer. In this manner, it is expected that a visually pleasing image will be obtained at a decoder even when resource limitations and other constraints prevent terminals from exchanging coded high resolution for an entire image.

In an embodiment, the controller 260 may select coding parameters or, alternatively, a range of parameters that will be applied by the coders 240.1, 240.2, . . . 240.N, which may vary differently for regions of an input frame that belong to ROIs and regions of the input frame that do not belong to ROIs. For example, the controller 260 may cause the base layer pipeline 270.1 to code ROI data at lower quality than non-ROI data. In one embodiment, the controller 260 may assign coding modes to ROI data in the base layer corresponding to SKIP mode coding, which causes the pixel blocks to be omitted from predictive coding and, by extension, yields an extremely low coding rate. Alternatively, the base layer pipeline 270.1 may be controlled to code pixel blocks within ROIs according to P- and/or B-coding modes but using a higher quantization parameter (QP) than for pixel blocks outside the ROI. Higher quantization parameters typically lead to higher compression with increased loss of data. By contrast, non-ROI may be coded at relatively high quality within a bit budget allocated to the base layer data. Thus, in either technique—SKIP mode coding or predictive coding with high QPs—the base layer pipeline causes ROI data to be coded at lower quality than it codes non-ROI data.

The controller 260 may cause the enhancement layer pipeline 270.2 to code ROI data at higher quality than it codes non-ROI data. In one embodiment, the controller 260 may assign coding modes to non-ROI data in the enhancement layer corresponding to SKIP mode coding, which causes the pixel blocks to be omitted from predictive coding and, by extension, yields an extremely low coding rate. Alternatively, the enhancement layer pipeline 270.2 may be controlled to code pixel blocks outside the ROIs according to P- and/or B-coding modes but using a higher quantization parameter (QP) than for pixel blocks inside the ROI. Again, higher quantization parameters typically lead to higher compression with increased loss of data. Thus, in either technique—SKIP mode coding or predictive coding with high QPs—the enhancement layer pipeline 270.2 causes non-ROI data to be coded at lower quality than it codes ROI data.

Coded data output from the coding pipelines 270.1, 270.2, . . . , 270.N may be output to a syntax unit. The syntax unit 250 may merge the coded video data from each pipeline into a unitary bit stream according to the syntax of a governing coding protocol. For example, the syntax unit 250 may generate a bit stream that conforms to the Scalable Video Coding (SVC) extensions of H.264/AVC, the scalability extensions (SHVC) of HEVC and the like. The syntax unit may output a protocol-compliant bit stream to other components of a terminal (FIG. 1), which may process the bit stream further for transmission.

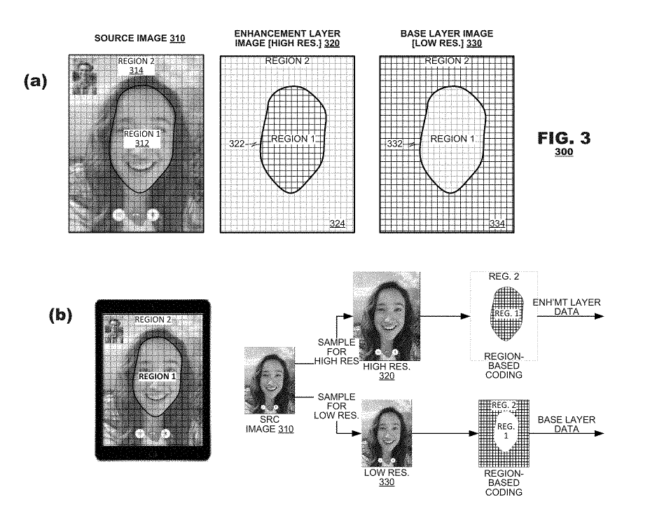

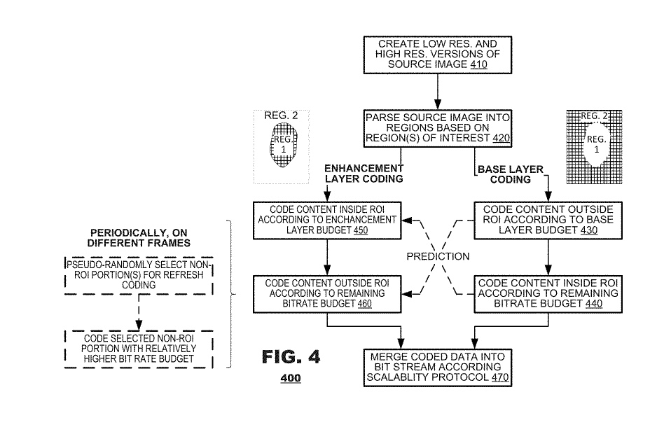

FIG. 3(a) illustrates exemplary image data that may be processed by the system 200 of FIG. 2, in an embodiment. As indicated, two copies of a source image 310 may be created—an enhancement layer image 320 and a base layer image 330. The enhancement layer image 320 may have a higher resolution than the corresponding base layer image 330. In parallel, the source image 310 may be parsed into a plurality of regions 312, 314 based on a predetermined ROI detection scheme. The regions 312, 314 thus will have counterpart regions 322, 324 and 332, 334 in the enhancement layer image 320 and the base layer image 330, respectively. These regions are illustrated in FIG. 3(a).

FIG. 3(b) illustrates processing operations that may be applied to the images of FIG. 3(a) by the embodiment of FIG. 2. As discussed, the source image 310 is resampled to a high resolution representation 320 for enhancement layer coding, and it also is resampled to a low resolution representation 330 for base layer coding. The base layer and enhancement layer coding each applies different coding to the ROI region (region 1) and to the non-ROI region (region 2) of their respective images 320, 330. In the base layer coding, coding is applied to the non-ROI region 334 at higher quality than the ROI region 332, within constraints imposed by a bitrate budget provided to the base layer. In the enhancement layer coding, coding is applied to the ROI region 322 at higher quality than the non-ROI region 324, again within constraints imposed by a bitrate budget provided to the enhancement layer. Thus, the coded bit stream will have high quality coded representations of each of the regions 312, 314, albeit in different layers with different resolutions. In the example of FIG. 3(b), the ROI region 312 will be coded by the enhancement layer at high resolution with high quality and the non-ROI region 314 will be coded by the base layer at lower resolution but with high quality.

FIG. 4 illustrates a coding method 400 according to an embodiment of the present disclosure. The method may create low resolution and high resolution versions of a source image according to resolutions of a base layer coding session and an enhancement layer coding session, respectively (box 410). The method may parse the source image in regions based on ROI detection techniques (box 420) such as those described above. Thereafter, the method 400 may engage base layer and enhancement layer coding.

For base layer coding, the method 400 may code content of the low resolution version of the source image according to a bitrate budget that is assigned to the base layer. Specifically, the method may code content of the non-ROI region according to a portion of the base layer budget that is assigned to the non-ROI region (box 430). The method 400 also may code content of the ROI region according to any remaining base layer budget that is not consumed by coding of the non-ROI region (box 440). In some embodiments, the non-ROI region may be assigned most of the budget assigned for base layer coding, in which case the ROI region may not be coded substantive (e.g., content within the ROI region may be coded by SKIP mode coding). In other embodiments, however, the non-ROI region may be assigned some lower amount of the base layer budget, for example 90% or 80% of the overall base layer bit rate budget, in which case coarse coding of the ROI region can occur in the base layer.

For enhancement layer coding, the method 400 may code content of the high resolution version of the source image according to a bitrate budget that is assigned to the enhancement layer. Specifically, the method may code content of the ROI region according to a portion of the enhancement layer budget that is assigned to the ROI region (box 450). The method 400 also may code content of the non-ROI region according to any remaining enhancement layer budget that is not consumed by coding of the ROI region (box 460). In some embodiments, the ROI region may be assigned most of the budget assigned for enhancement layer coding, in which case the non-ROI region may not be coded substantively (e.g., content within the non-ROI region may be coded by SKIP mode coding). In other embodiments, however, the ROI region may be assigned some lower amount of the enhancement layer budget, for example 90% or 80% of the overall enhancement layer bit rate budget, in which substantive coding of the ROI region can occur in the enhancement layer.

Coding operations performed in the base layer coding (boxes 430, 440) and in enhancement layer coding (boxes 450, 460) may be performed predictively. Predictive coding involves a selection of a coding mode (e.g., I-coding, P-coding, B-coding or SKIP coding, etc.) and selection of coding parameters that define how the selected coding parameters are performed. Some parameter selections, particularly motion vectors, involve a resource intensive search for a best parameter for use in coding. For example, a motion vector search often involves a comparison of image data between a block of a frame being coded and blocks of candidate prediction data at several different locations in a reference frame to identify a block that provides a closest prediction match to the input block. In an embodiment, when the method 400 performs enhancement layer coding of ROI data (box 450) coding mode selections and/or motion vectors may be derived from mode selections and motion vectors selected during coding of the ROI at the base layer (box 440). Similarly, when the method 400 performs enhancement layer coding of non-ROI data (box 460) coding mode selections and/or motion vectors may be derived from mode selections and motion vectors selected during coding of the non-ROI region at the base layer (box 430). Such derivations, however, need not occur in all embodiments. For example, in box 450, SKIP mode decisions made during base layer coding (box 440) may not be used in coding of ROI data in the enhancement layer.

For example, for non-ROI data, an enhancement layer coder 240.2 may conserve processing resources that otherwise would be spent on motion prediction searches simply by applying a motion vector of a pixel block from a common location in image data, as determined by a base layer coder 240.2. Shown in FIG. 5, a pixel block 522 of an enhancement layer image 520 may be predicted from base layer data and an enhancement layer reference picture 525. First, a base layer motion vector mv_{b} that extends between the base layer input image 510 and a base layer reference picture 515 may be scaled according to the resolution ratios between the base layer image 510 and the enhancement layer image 520 and used to identify a prediction pixel block Pe in an enhancement layer reference picture 525 that corresponds to the base layer reference picture 515. Prediction data for the enhancement layer pixel block 522 may be derived from content of the base layer pixel block 512 and content of the prediction pixel block Pe in the enhancement layer reference picture 522. In an embodiment, prediction may occur as:

T=w1*Pe+w2*Pb, where (1.)

T represents the predicted content of the enhancement layer pixel block 522 and w1 and w2 represent respective weights. The weights w1, w2 may be set to predetermined values (e.g., w1=w2=0.5) or they may be derived by an encoder and signaled to a decoder in coded video data.

Alternatively, prediction may occur as:

T=w1*HighFreq(Pe)+w2*Pb, where (2.)

T represents the predicted content of the enhancement layer pixel block 522, w1 and w2 represent respective weights and the HighFreq(Pe) operator represents a process that extracts high frequency content from the reference enhancement layer pixel block Pe. In an embodiment, the HighFreq(Pe) operator simply may be a selector that selects transform coefficients (e.g., DCT or wavelet coefficients) that correspond to the resolution differences between the enhancement layer and the base layer.

Alternatively, instead of relying solely on a base layer motion vector mvb as the basis of an enhancement layer motion vector mvₑ, motion vectors of other base layer pixel blocks neighboring the co-located base layer pixel block 512 may be tested as candidates for coding.

In an embodiment, improved visual quality is expected to be obtained by preferentially coding portions of non-ROI regions according to a refresh selection pattern. In a default coding mode, particularly where bandwidth allocated to enhancement layer coding of non-ROI regions is small, many pixel blocks may be coded according to a SKIP coding mode, which causes co-located data from preceding frames to be reused for a new frame being coded. Image content of the SKIP-ed blocks may not be perfectly static and, therefore, the reuse of image content may cause abrupt discontinuities when the SKIP-ed blocks eventually are coded according to some other mode. In an embodiment, enhancement layer coding may be performed according to a refresh coding policy that preferentially allocates bandwidth assigned to enhancement layer coding of non-ROI data to a sub-set of the pixel blocks belonging to the non-ROI region of each frame.

According to this embodiment, while enhancement layer coding non-ROI regions of a high resolution frame (box 460), the method 400 may select a sub-set of non-ROI pixel blocks according to a refresh selection pattern (box 462). The method 400 then may predictively code the selected pixel blocks from the non-ROI region (box 464), which causes coding according to a mode other than a SKIP mode. In this manner, the method 400 may force non-SKIP coding of a sub-set of non-ROI pixel blocks in each frame, which imparts some amount of precision to those pixel blocks when they are decoded. The remaining pixel blocks likely will be coded according to SKIP mode coding in the enhancement layer, which will cause them to appear as low resolution versions when decoded; those other pixel block may be selected by the refresh selection pattern during coding of some other frame and thus high resolution components of the non-ROI may be refreshed albeit at a lower rate than ROI pixel blocks of the enhancement layer.

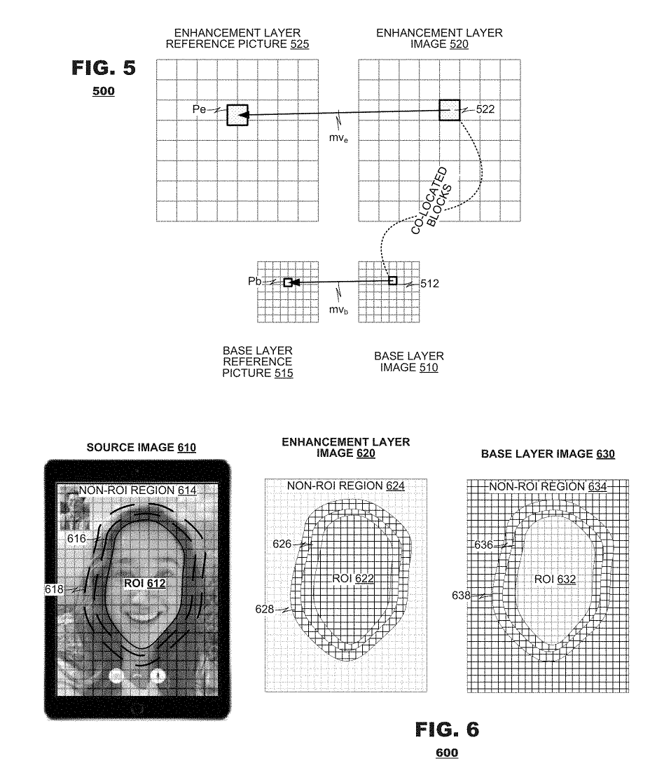

The principles of the present disclosure accommodate other processing techniques to smooth out visual artifacts that may be observed between coded high resolution and coded low resolution content. In one embodiment, video coders may vary coding parameters applied to video content along boundaries between a ROI and non-ROI content. FIG. 6 illustrates an exemplary source image 610 that has been parsed into a ROI 612 and a non-ROI region 614, for which zones 616, 618 are defined between the ROI 612 and non-ROI region 614. According to the embodiment of FIG. 6, when coding a high resolution enhancement layer image 620, an encoder may code an ROI 622 at a first, relatively high level of quality, the non-ROI 624 at second, lower level of quality and the intermediate zones 626, 628 at intermediate levels of quality. Such quality levels may be defined by application of coding budget and quantization parameters.

Similarly, when coding a low resolution base layer image 630, an encoder may code a non-ROI region 634 at a first, relatively high level of quality, the ROI 632 at second, lower level of quality and the intermediate zones 638, 636 at intermediate levels of quality. Such quality levels may be defined by application of coding budget and quantization parameters.

Smoothing of visual artifacts may be performed at a decoder as well. For example, a decoder may apply various filtering operations, such as deblocking filters, smoothing filters and pixel blending across boundaries between the ROI content 612 and non-ROI content 614, between those regions 612, 614 and the zones 616, 618 and between the zones 616, 618 themselves as needed.

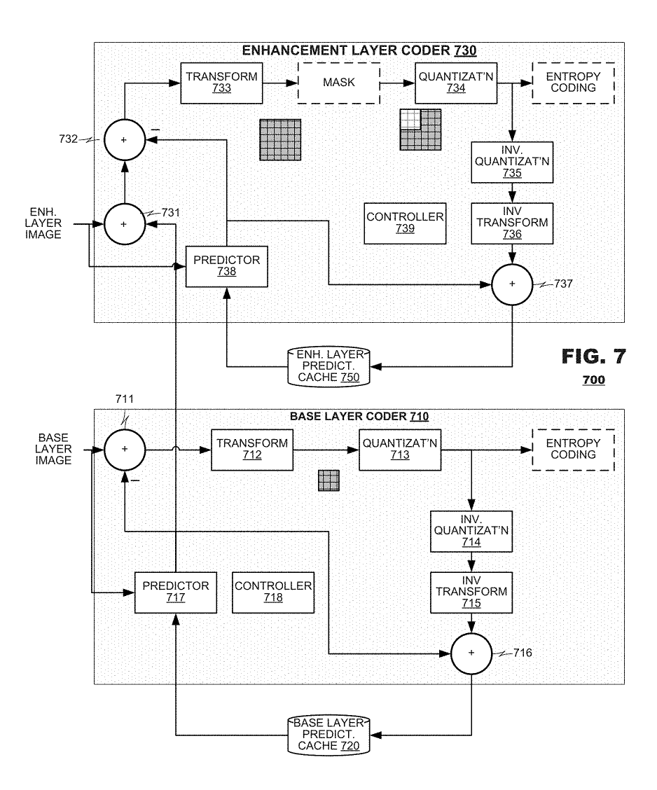

FIG. 7 illustrates another coding system 700 according to an embodiment of the present disclosure. The system 700 may include a base layer coder 710, a base layer prediction cache 720, an enhancement layer coder 730 and an enhancement layer prediction cache 750. The base layer coder 710 and the enhancement layer coder 730 code base layer images and enhancement layer images, respectively, which may be generated according to the techniques of the foregoing embodiments. The prediction caches 720, 750 may store decoded data that represents decoded base layer data and decoded enhancement layer data, respectively.

FIG. 7 illustrates simplified representations of the base layer coder 710 and the enhancement layer coder 730. The base layer coder 710 may include a forward coding pipeline that includes a subtractor 711 and a transform unit 712, as well as other units to code pixel blocks of the base layer image (such as an entropy coder). The base layer coder 710 also may include a prediction system that includes an inverse quantizer 714, an inverse transform unit 715, an adder 716 and a predictor 717. Operation of the base layer coder 710 may be controlled by a controller 718.

The operation of base layer coding units 711-717 typically is determined by the coding protocols to which the coder 710 conforms, such as H.263, H.264 or H.265. Generally speaking, the base layer coder 710 operates on a ‘pixel block’-by-′pixel block′ basis as determined by the coding protocol to assign a coding mode to the pixel block and then code the pixel block according to the selected mode. When a prediction mode selects data from the prediction cache 720 for prediction of a pixel block from the base layer image, the subtractor 711 may generate pixel residuals representing differences between the input pixel block and the prediction pixel block on a pixel-by-pixel basis. The transform unit 712 may convert the pixel residuals from the pixel domain to a coefficient domain by a predetermined transform, such as a discrete cosine transform, a wavelet transform, or other transform that may be defined by the coding protocol. The quantization unit 713 may quantize transform coefficients generated by the transform unit 712 by a quantization parameter (QP) that is communicated to a decoder (not shown).

The transform coefficients typically content of the pixel block residuals across predetermined frequencies in the pixel block. Thus, the transform coefficients represent frequencies of image content that are observable in the base layer image.

The base layer coder 710 may generate prediction reference data by inverting the quantization, transform and subtractive processes for base layer images that are designated to serve as reference pictures for other frames. These inversion processes are represented as units 714-716, respectively. Reassembled decoded reference frames may be stored in the base layer prediction cache 720 for use in prediction of later-coded frames.

The base layer coder 710 also may include a predictor 717 that assigns a coding mode to each coded pixel block and, when a predictive coding mode is selected, outputs the prediction pixel block to the subtractor 711.

The enhancement layer coder 730 may have an architecture that is determined by the coding protocol to which it conforms. Generally, the enhancement layer coder 730 may include a forward coding pipeline that includes a pair of subtractors 731, 732 and a transform unit 733, as well as other units to code pixel blocks of the base layer image (such as an entropy coder). The enhancement layer coder 730 also may include a prediction system that includes an inverse quantizer 735, an inverse transform unit 736, an adder 737 and a predictor 738. Operation of the base layer coder 730 may be controlled by a controller 739.

The enhancement layer coder 730 also may operate on a ‘pixel block’-by-′pixel block′ basis as determined by the coding protocol to assign a coding mode to the pixel block and then code the pixel block according to the selected mode. The enhancement layer coder 730 may accept two sets of prediction data, a prediction pixel block from the base layer coder (which is scaled according to resolution differences between the enhancement layer image and the base layer image) and prediction data from the enhancement layer cache 750. Thus, the first subtractor 731 may generate first prediction residuals from comparison with the base layer prediction data and the second subtractor 732 may revise the first prediction residuals from comparison with enhancement layer prediction data. The revised prediction residuals may be input to the transform unit 733.

The transform unit 733 and the quantizer 734 may operate in a manner similar to their counterparts in the base layer coder 710. The transform unit 733 may convert the pixel residuals from the pixel domain to the coefficient domain by a predetermined transform, such as a discrete cosine transform, a wavelet transform, or other transform that may be defined by the coding protocol. The quantization unit 734 may quantize transform coefficients generated by the transform unit 733 by a quantization parameter (QP) that is communicated to a decoder (not shown).

The enhancement layer coder 730 may generate prediction reference data by inverting the quantization, transform and subtractive processes for base layer images that are designated to serve as reference pictures for other frames. These inversion processes are represented as units 735-737, respectively. Reassembled decoded reference frames may be stored in the enhancement layer prediction cache 750 for use in prediction of later-coded frames. The predictor 738 may assign a coding mode to each coded pixel block and, when a predictive coding mode is selected, outputs the prediction pixel block to the subtractor 732.

As with the base layer coder 710, transform coefficients generated within the enhancement layer coder 730 typically represent content of the pixel block residuals across predetermined frequencies in the pixel block. The enhancement layer image will have higher resolution than its corresponding base layer image and, therefore, the transform coefficients generated in the enhancement layer coder 730 will represent a higher range frequencies than the corresponding coefficients generated in the base layer coder 710. In an embodiment, a controller 739 in the enhancement layer coder may nullify frequency coefficients that are generated in the enhancement layer that are redundant to those generated in the base layer coder 710. This process is represented by the “MASK” unit illustrated in FIG. 7. In practice, this process may be performed at any stage prior to an entropy coder or other run-length coder in the enhancement layer coder 730.

Image reconstruction at a decoder (not shown) may perform operations represented by the inverse coding units 714-716, 735-737 and predictors 717, 738 of the base layer and enhancement layer coders 710, 730 respectively. For a given source pixel block ORG in a source image, an upsampled prediction of the base layer coded pixel block will be taken to represent low frequency content of the pixel block ORG and coded enhancement layer data will be taken to represent the source pixel block at higher frequencies. Therefore a decoded pixel block ORG′ will be derived as:

ORG′=LOW(ORG)+HIGH(ORG), where (3)

the LOW( ) and HIGH( ) operators represent low frequency and high frequency predictions of the base layer coding and enhancement layer coding, respectively.

In Eq. (3), the high frequency components of ORG may be derived by HIGH(ORG)=ORG−LOW(ORG), where LOW(ORG) may be derived by upsampling the base layer image data from the base layer image's native resolution to a resolution of the enhancement layer image. Similarly, prediction references for the enhancement layer data may be derived as HIGH(REF)=REF−LOW(REF), which may be derived by upsampling the downsampled reference pictures REF.

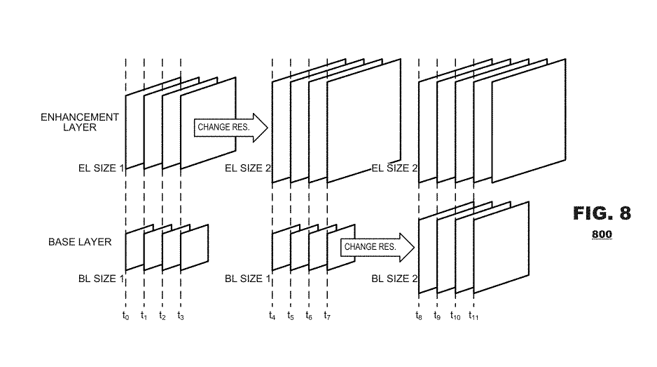

The principles of the present disclosure find application with variable resolution adaptation (VRA) techniques, which permit coders to vary resolution of frames being coded within a coding session. VRA techniques are described generally in U.S. Pat. No. 9,215,466 and U.S. Publication No. 2012/0195376, the disclosures of which are incorporated herein. FIG. 8 illustrates application of VRA to base layer and enhancement layer coding according to the principles of FIG. 2. As illustrated in the example of FIG. 8, base layer and enhancement layer coding may occur initially using frames of first sizes. Thus, FIG. 8 illustrates frames of the base layer and the enhancement layer being processed at initial first sizes (labeled “BL Size 1” and “EL Size 1,” respectively) in frames t₀-t₄. Thereafter, resolution of the enhancement layer coding may be increased from EL Size 1 to EL Size 2. From frames t₄-t₇, coding may occur in the base layer at BL Size 1 and in the enhancement layer at EL Size 2. Thereafter, resolution of the base layer coding may be increased from BL Size 1 to BL Size 2. From frames t₈-tᵢᵢ, coding may occur in the base layer at BL Size 2 and in the enhancement layer at BL Size 2.

Thus, integration of VRA techniques with the coding techniques described in the foregoing embodiments permits a coding system to respond to changes in coding bandwidth in a graceful manner. Resolution of the multiple coding layers may be selected to optimize coding quality given an overall bandwidth available for coding. When bandwidth increases, a coding system may increase first the coding resolution applied to regions of interest, which are represented most accurately in the enhancement layer and increase resolution applied to non-ROI regions in the base layer if supplementary bandwidth is available. Similarly, if coding circumstances change and bandwidth decreases, an encoder may respond by lowering resolution first in the base layer, which may preserve coding resolution for the regions of interest, before changing resolution of the enhancement layer.

In an embodiment, the coding resolutions may progress though a sequence such as:
Base layer resolution may be chosen as QVGA initially and an enhancement layer may be chosen as HVGA.
As bandwidth increases, the enhancement layer may be increased to VGA.
Base layer resolution may be increased to QVGA simultaneously with the resolution increase in the enhancement layer or, optionally, may be performed after the resolution increase in the enhancement layer, which permits an encoder to confirm the bandwidth increase is a stable event before allocating additional bandwidth to the base layer coding.
Further increases in bandwidth may warrant further resolution increases among the enhancement layer and the base layer.
   Eventually, bandwidth may rise to a level where it is unnecessary to code ROI data and non-ROI data at different resolutions. In this circumstance, the coder may increase a resolution of the base layer data to a quality level, for example, VGA, that is sufficient to code ROI and may code all image content through the base layer coder. In this circumstance, enhancement layer coding may cease.

The principles of the disclosure also find application with frame rate adaptation. In this embodiment, base layer images may be coded at lower frame rates than enhancement layer frames. On decode, a decoder (not shown) may interpolate base layer content at temporal positions that coincide with temporal positions of the decoded enhancement layer images and merge the interpolated base layer content and decoded enhancement layer content into a final representation of the decoded frame.

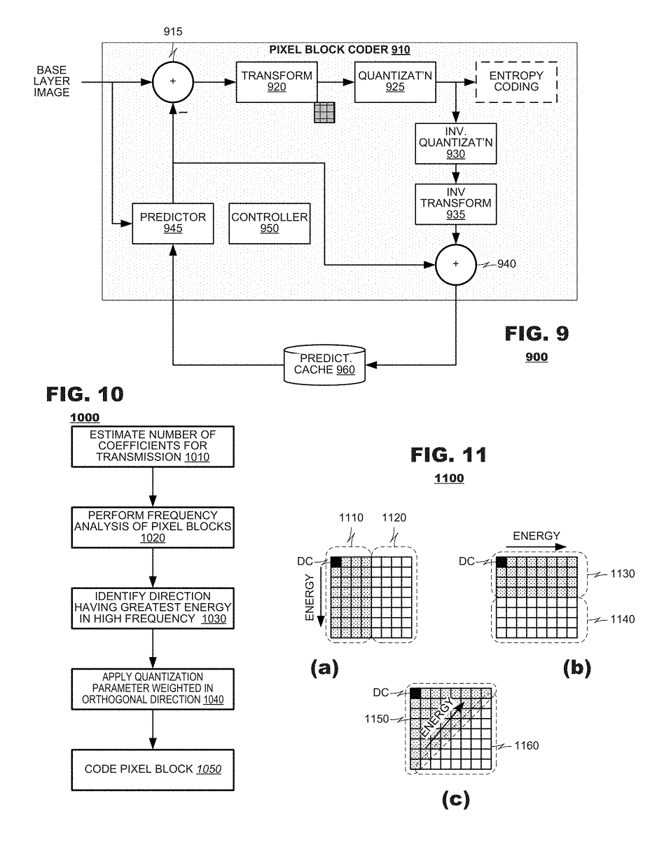

FIG. 9 illustrates a coding system 900 according to another embodiment of the present disclosure. The system 900 may include a pixel block coder 910 and a prediction cache 960. The pixel block coder 910 may include a forward coding pipeline that includes a subtractor 915, a transform unit 920, and a quantizer 925, as well as other units to code pixel blocks of an input image (such as an entropy coder). The pixel block coder 910 also may include a prediction system that includes an inverse quantizer 930, an inverse transform unit 935, an adder 940 and a predictor 945. Operation of the pixel block coder 910 may be controlled by a controller 950.

The operation of coding units 915-950 typically is determined by the coding protocols to which the coder 910 conforms, such as H.263, H.264 or H.265. Generally speaking, the coder 900 operates on a pixel block-by-pixel block basis as determined by the coding protocol to assign a coding mode to the pixel block and then code the pixel block according to the selected mode. When a prediction mode selects data from the prediction cache 960 for prediction of a pixel block from the input image, the subtractor 915 may generate pixel residuals representing differences between the input pixel block and the prediction pixel block on a pixel-by-pixel basis. The transform unit 920 may convert the pixel residuals from the pixel domain to a coefficient domain by a predetermined transform, such as a discrete cosine transform, a wavelet transform, or other transform that may be defined by the coding protocol. The quantization unit 925 may quantize transform coefficients generated by the transform unit 920 by a quantization parameter (QP) that is communicated to a decoder (not shown).

The pixel block coder 910 may generate prediction reference data by inverting the quantization, transform and subtractive processes for coded images that are designated to serve as reference pictures for other frames. These inversion processes are represented as units 930-940, respectively. Reassembled decoded reference frames may be stored in the prediction cache 90 for use in prediction of later-coded frames. The predictor 945 may assign a coding mode to each coded pixel block and, when a predictive coding mode is selected, outputs the prediction pixel block to the subtractor 915.

The system 900 of FIG. 9 may be used to provide multiresolution coding of video using single layer coding techniques. According to this embodiment, a controller 950 may alter transform coefficients prior to entropy coding according to frequency components of the image data being coded.

FIG. 10 illustrates a method 1000 according to an embodiment of the present disclosure. The method of FIG. 10 may be implemented by a controller 950 of a single layer coding system 900 (FIG. 9). The method 1000 may estimate a number of coefficients to be transmitted (box 1010). The estimate may be performed on a per pixel block basis, a per frame basis or according to larger constructs of video coding (e.g., per GOP or per session). The method also may perform a frequency analysis of image content within an input pixel block (box 1020) and may identify a direction within the pixel block having the greatest energy in high frequency components (box 1030). The method may alter transform coefficients to reduce the distribution of coefficients in a direction orthogonal to the direction identified in box 1030 (box 1040). The method 1000 may code the resultant pixel block (box 1050).

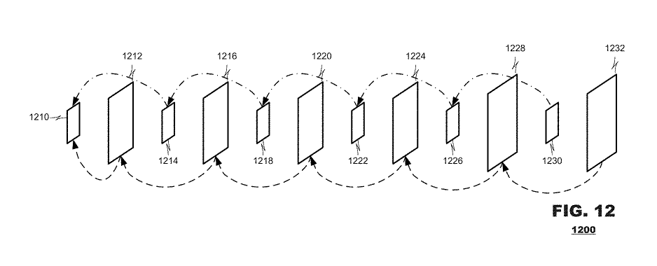

FIG. 11 illustrates operation of the method 1000 as applied to exemplary transform coefficients. Typically, transform coefficients are organized into an array in which a first coefficient position represents average image content of the pixel block (commonly, the “DC” coefficient). Other positions of the coefficient array represent image content at predetermined frequencies (which are called “AC” coefficients). The value of each coefficient represents the relative energy of the coefficient as compared to others.

FIG. 11(a) illustrates a circumstance in which AC coefficients show larger energy in a vertical direction along a coefficient array than along the horizontal direction. Thus, a first set of coefficients 1110 in a vertical column have larger energy than a second set of coefficients 1120 in a second vertical column. In response, the method 1000 may alter coefficients of the second set to increase coding efficiency. Typically, the second set of coefficients may be set to zero, which may improve coding efficiencies of latter coding operations (such as entropy coding).

FIG. 11(b) illustrates a circumstance in which AC coefficients show larger energy in a horizontal direction along a coefficient array than along the vertical direction. Thus, a first set of coefficients 1130 in a horizontal row have larger energy than a second set of coefficients 1120 in a second horizontal row. In response, the method 1000 may alter coefficients of the second set to increase coding efficiency. Typically, the second set of coefficients may be set to zero, which may improve coding efficiencies of latter coding operations (such as entropy coding).

FIG. 11(c) illustrates a circumstance in which AC coefficients show larger energy along a diagonal direction along a coefficient array than along other possible diagonals. Thus, a set of coefficients in a first segment 1130 of the array, which is defined by the diagonal, has larger energy than a set of coefficients in a second segment 1120. In response, the method 1000 may alter coefficients of the second set 1120 to increase coding efficiency. Again, the second set of coefficients may be set to zero.

HEVC coding employs a significance map to identify to a decoder pixel blocks that have non-zero coefficients. In an embodiment, an encoder may choose coefficient groups adaptively to maximize coding efficiency.

Returning to FIG. 9, when a predictor 945 searches for prediction references between input pixel blocks and reference pixel blocks, it may be useful to do so in a transform domain rather than a pixel block. Doing so allows the predictor to perform comparisons using a reduced set of coefficients, which correspond to those coefficients that will be preserved during coding.

In an embodiment, rather than setting coefficient values in the second sets 1120, 1140, 1160 (FIG. 11) to zero, a coder may employ a non-uniform quantization parameter to coefficients, in which the quantization parameter increases along a direction of the array that is orthogonal to a direction of coefficient energy.

When estimating the number of coefficients to use for coding (FIG. 10, box 1010), an encoder may assign different numbers of coefficients to different regions of input images. For example, an input image may be parsed into ROI regions 312 and non-ROI regions 314 as shown in FIG. 3(a) or, alternatively, may be parts into ROI regions 612, non-ROI regions 614 and border zones 616, 618 as shown in FIG. 6. An encoder may assign different numbers of coefficients to transmit for pixel blocks in each such region 312, 314, 612, 614 and each such zone 616, 618, which has an effect of varying resolution of image content of pixel blocks in such regions.

Additionally, the techniques of FIG. 10 may find application in multi-layer coders. In such an embodiment, the method 1000 may be performed by controllers of base layer coders and enhancement layer coders (FIGS. 2, 7) with different numbers of coefficients selected by each layer's coder based on the regions 312, 314, 612, 614 and/or zones 616, 618 that the coders are coding.

Embodiments of the present disclosure also accommodate multi-resolution coding of image data in a single layer coder by coding frames of different resolutions in logically separated sessions. FIG. 12 shows an example in which a video coding session that includes frames 1210-1232 has a first sub-set of frames 1210, 1214, 1218, 1222, 1226, 1230 that are coded by the video coder at a first resolution, and a second sub-set of frames 1212, 1216, 1220, 1224 that are coded at a second, higher resolution. A coder may manage prediction references among the frames so that the smaller resolution frames 1210, 1214, 1218, 1222, 1226, 1230 refer only to other smaller resolution frames as sources of prediction. The coder also may manage prediction references among the larger-sized frames 1212, 1216, 1220, 1224 so that they refer to other larger-sized frames. Exceptions can arise around scene changes and other coding events that cause a refresh the larger-sized frames. If no adequate prediction reference for a larger-sized frame (for example, frame 1212 in FIG. 12), then the larger-sized frame may refer to a smaller frame 1210 as a prediction reference, which would be upsampled and serve as a prediction reference. In this manner, a single video coder (FIG. 9) may code frames of different resolutions.

The embodiment of FIG. 12 may be used cooperatively with techniques of other embodiments. For example, frames 1228, 1232 are illustrated as having larger sizes than their counter-part frames 1212, 1216, 1220, and 1224. An encoder that manages prediction chains among the larger-size frames and smaller-sized frames as shown in FIG. 12 may employ video resolution adaptation techniques and increase or decrease resolution of coded frames, much as a base layer coder and an enhancement layer coder (FIG. 7) may do.

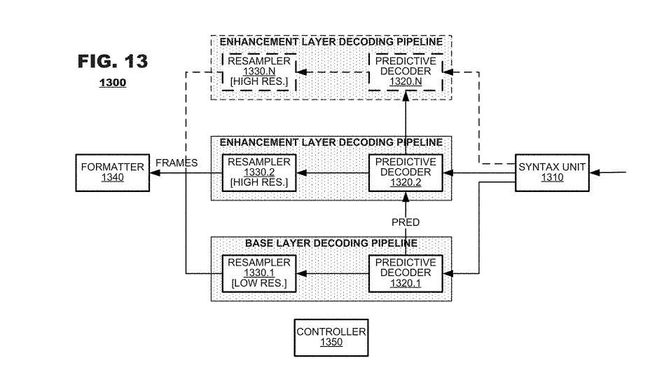

FIG. 13 is a functional block diagram of a decoding system 1300 according to an embodiment of the present disclosure. The decoding system 1300 may decode coded video data received from a channel. The coded video data may include coded data output by a base layer coder and enhancement layer coder, such as the coders illustrated in FIGS. 2 and 7, which may have been coded at different resolutions. The system 1300 may include a syntax unit 1310, a plurality of predictive decoders 1320.1, 1320.2, . . . , 1320.N, a plurality of resamplers 1330.1, 1330.2, . . . , 1330.N, and a formatter 1340 all operating under control of a controller 1350.

The syntax unit 1310 may parse coded data into its constituent streams and forward those streams to respective decoders. Thus, the syntax unit 1310 may route coded base layer data and coded enhancement layer data to the predictive decoders 1320.1, 1320.2, . . . , 1320.N to which they belong. The predictive decoders 1320.1, 1320.2, . . . , 1320.N may decode the coded data of their respective layers and may output recovered frame data. The recovered frame data from each layer's decoder 1320.1, 1320.2, . . . , 1320.N may be output at the resolution(s) at which those layers were coded. The resamplers 1330.1, 1330.2, . . . , 1330.N may change the resolution of the streams to a common resolution representation, typically a resolution that matches the resolution of the highest-resolution enhancement layer. The formatter 1340 may merge the output from the resamplers 1330.1, 1330.2, . . . , 1330.N to a common output signal, which may be displayed or stored for further uses

The foregoing discussion has described operation of the foregoing embodiments in the context of terminals, coders and decoders. Commonly, these components are provided as electronic devices. They can be embodied in integrated circuits, such as application specific integrated circuits, field programmable gate arrays and/or digital signal processors. Alternatively, they can be embodied in computer programs that execute on personal computers, notebook computers, computer servers or mobile computing platforms such as smartphones and tablet computers. As such, these programs may be stored in memory of those devices and be executed by processors within them. Similarly, decoders can be embodied in integrated circuits, such as application specific integrated circuits, field programmable gate arrays and/or digital signal processors, or they can be embodied in computer programs that execute on personal computers, notebook computers, computer servers or mobile computing platforms such as smartphones and tablet computers. Decoders commonly are packaged in consumer electronics devices, such as gaming systems, DVD players, portable media players and the like and they also can be packaged in consumer software applications such as video games, browser-based media players and the like. Again, these programs may be stored in memory of those devices and be executed by processors within them. And, of course, these components may be provided as hybrid systems that distribute functionality across dedicated hardware components and programmed general purpose processors as desired.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A video coding method, comprising:
generating at least two representations of an input frame at a high and a low resolution, respectively;
identifying a region of interest (ROI) from within the input frame;
coding the low resolution representation of the input frame according to predictive coding techniques in which a region of the low resolution representation that is outside the ROI is coded at higher quality than a region of the low resolution representation that is inside the ROI; and
coding the high resolution representation of the input frame according to predictive coding techniques in which a region of the high resolution representation that is inside the ROI is coded at higher quality than a region of the high resolution representation that is outside the ROI.

2. The method of claim 1, wherein the low resolution representation is coded by base layer coding and the high resolution representation is coded by enhancement layer coding.

3. The method of claim 1, further comprising repeating the generating and the two coding steps for a plurality of input images, wherein:
the low resolution representation and the high resolution representation of the input frames are coded by a single-layer coder, and
prediction references among the coded low resolution representations are confined to other low resolution representations of the input image.

4. The method of claim 1, wherein the coding of the low resolution representation of non-ROI regions is performed at higher quality in an area adjacent to the ROI than for an area that is not adjacent to the ROI.

5. The method of claim 1, further comprising repeating the generating and the two coding steps for a plurality of input images, wherein the coding of the high resolution representation includes:
selecting a portion of the non-ROI region according to a refresh selection pattern, and
coding the selected portion of the non-ROI region at higher coding quality than coding of the non-selected portion of the non-ROI region.

6. The method of claim 1, wherein one of the coding steps comprises:
transforming pixel data of the respective representation to an array of transform coefficients representing frequency content of the pixel data;
identifying high-energy transform coefficients in the array;
altering other, lower-energy transform coefficients; and
coding the array of transform coefficients, including the altered coefficients.

7. The method of claim 1, wherein:
the coding of the low resolution representation includes transforming pixel data to first transform coefficients representing content of the low resolution representation at a first range of frequencies; and
the coding of the high resolution representation includes:
transforming pixel data to second transform coefficients representing content of the high resolution representation at a second range of frequencies larger than the first range;
discarding second transform coefficients that correspond to frequencies at the first range; and
coding a remainder of the second transform coefficients.

8. The method of claim 1, wherein:
the coding of the low resolution representation includes transforming pixel data to first transform coefficients representing content of the low resolution representation at a first range of frequencies; and
the coding of the high resolution representation includes:
transforming pixel data to second transform coefficients representing content of the high resolution representation at a second range of frequencies larger than the first range;
combining second transform coefficients that correspond to frequencies at the first range with first transform coefficients at those corresponding frequencies; and
coding a remainder of the second transform coefficients.

9. A video coding method, comprising:
generating base layer and enhancement layer representations of an input frame, the enhancement layer representation having higher resolution than the base layer representation,
identifying a region of interest (ROI) from within the input frame;
base layer coding the base layer representation of the input frame in which a region of the base layer representation that is outside the ROI is coded at higher quality than a region of the base layer representation that is inside the ROI; and
enhancement layer coding the enhancement layer representation of the input frame in which a region of the enhancement layer representation that is inside the ROI is coded at higher quality than a region of the enhancement layer representation that is outside the ROI.

10. The method of claim 9, wherein:
the base layer coding and enhancement layer coding are predictive coding operations, and
prediction references of the enhancement layer coding are derived from prediction references of the base layer coding.

11. The method of 9, further comprising repeating the generating, base layer coding and enhancement layer coding for a plurality of input images, wherein the generating varies resolutions of different enhancement layer representations of the input images.

12. The method of claim 9, wherein, when the identifying identifies multiple ROIs within the input frame:
the enhancement layer coding comprises coding a first ROI by a first enhancement layer coding and coding a second ROI by a second enhancement layer coding, wherein each enhancement layer coding codes a region inside the respective ROI at higher quality than a region outside the respective ROI. The method of 9, wherein the base layer coding of non-ROI regions is performed at higher quality in an area adjacent to the ROI than for an area that is not adjacent to the ROI.

13. The method of 9, wherein the enhancement layer coding includes:
selecting a portion of the non-ROI region according to a refresh selection pattern, and
coding the selected portion of the non-ROI region at higher coding quality than coding of the non-selection portion of the non-ROI region.

14. The method of 9, wherein:
the base layer coding includes transforming pixel data to first transform coefficients representing content of the base layer representation at a first range of frequencies;
the enhancement layer coding includes:
transforming pixel data to second transform coefficients representing content of the enhancement layer representation at a second range of frequencies larger than the first range;
discarding second transform coefficients that correspond to frequencies at the first range; and
coding a remainder of the second transform coefficients.

15. The method of 9, wherein:
the base layer coding includes transforming pixel data to first transform coefficients representing content of the base layer representation at a first range of frequencies;
the enhancement layer coding includes:
transforming pixel data to second transform coefficients representing content of the enhancement layer representation at a second range of frequencies larger than the first range;
combining second transform coefficients that correspond to frequencies at the first range with first transform coefficients at those corresponding frequencies; and
coding a remainder of the second transform coefficients.

16. The method of 9, wherein one of the base layer and enhancement layer coding comprises:
transforming pixel data of the respective layer to an array of transform coefficients representing frequency content of the pixel data;
identifying a direction of energy in the array of the transform coefficients;
altering transform coefficients along a direction orthogonal to the identified direction; and
coding the array of transform coefficients, including the altered coefficients.

17. A video coder, comprising:
a first resampler having an input for an input image and an output for resampled image data at a first resolution,
a base layer coder having an input coupled to the output of the first resampler;
a second resampler having an input for the input image and an output for resampled image data at a second resolution, greater than the first resolution;
an enhancement layer coder having an input coupled to the output of the second resampler;
a region of interest detector having an input for the input image;
a controller, to provide coding parameters to the base layer coder and the enhancement layer coder, causing the base layer coder to code first resolution image data outside a region of interest (ROI) at higher quality than first resolution image data inside the ROI and causing the enhancement layer coder to code first resolution image data inside the ROI at higher quality than first resolution image data outside the ROI.

18. The video coder of claim 17, wherein:
the base layer coder and enhancement layer coder are predictive coders, and
the enhancement layer coder has an input for prediction references developed by the base layer coder.

19. The video coder of claim 17, wherein one of the resampler varies resolution of its output during a coding session.

20. The video coder of claim 17, wherein the base layer coder codes non-ROI regions at higher quality in an area adjacent to the ROI than for an area that is not adjacent to the ROI.

21. The video coder of claim 17, wherein the enhancement layer coder:
selects a portion of the non-ROI region according to a refresh selection pattern, and
codes the selected portion of the non-ROI region at higher coding quality than coding of the non-selection portion of the non-ROI region.

22. The video coder of claim 17, wherein:
the base layer coder includes a transform unit that generates transform coefficients representing content of the first resolution input frame at a first range of frequencies;
the enhancement layer coder includes
a transform unit that generates second transform coefficients representing content of the second resolution input frame at a second range of frequencies larger than the first range; and
a controller that discards second transform coefficients that correspond to frequencies at the first range.

23. A video decoding method, comprising:
decoding video data coded as base layer data, the decoded base layer data representing a source image at a first resolution and having higher quality coding in a first region than for a second region;
decoding video data coded as enhancement layer data, the decoded enhancement layer data representing the source image at a second resolution higher than the first resolution and having higher quality in the second region than for the first region;
resampling at least one of the decoded base layer data and the decoded enhancement layer data to a common resolution; and
merging the resampled base layer data and enhancement layer data into a common image.

24. A computer readable medium storing program instructions that, when executed by a processing device, cause the processing device to:
generate two representations of an input frame at different resolutions;
identify a region of interest (ROI) from within the input frame;
code a low resolution representation of the input frame according to predictive coding techniques in which a region outside the ROI is coded at higher quality than a region inside the ROI; and
code a high resolution representation of the input frame according to predictive coding techniques in which a region inside the ROI is coded at higher quality than a region outside the ROI.

25. The medium of claim 24, wherein the low resolution representation is coded by base layer coding and the high resolution representation is coded by enhancement layer coding.

26. The medium of claim 24, wherein the device repeats the generating and the two coding steps for a plurality of input images, wherein:
the low resolution representation and the high resolution representations of the input frames are coded by single-layer coding, and
prediction references among the coded low resolution representations are confined to other low resolution representations of the input image.
